(19) United States
(12) Patent Application Publication
(10) Pub. No.: US 2008/0301328 A1
(43) Pub. Date: Dec. 4, 2008

(54) Method and system for improved communication between central processing units and input/output processors

(76) Inventors: Craig F. Russ, Berwyn, PA (US); Matthew A. Curran, Swarthmore, PA (US)

Correspondence Address: UNISYS CORPORATION, UNISYS WAY, MAIL STATION: E8-114, BLUE BELL, PA, 19424, US

(21) Appl. No.: 10/832,746

(22) Filed: Apr. 27, 2004

(51) Int. Cl. G06F 13/28

(52) U.S. Cl. 710/25

(57) ABSTRACT

A method and system for communicating information regarding input/output (IO) processing in a shared access to memory environment is disclosed. A central processing unit (CPU) and an input/output processor (IOP) are configured to write to and read from predetermined memory locations to manage the detection, performance, and completion of IOs. The CPU and the IOP may read from and write to memory as desired.

### FIELD OF INVENTION

The present invention relates to shared access to memory environments. More particularly, the present invention relates to improving communication between central processing units (CPUs) and input/output processors (IOPs) in shared access to memory environments where input/output processing is offloaded from a CPU to an IOP.

### BACKGROUND

Referring initially to FIG. 1, there is shown a prior art system 10 wherein a central processing unit (CPU) 22 residing in a computer 12 such as, for example, a mainframe computer is connected to an input/output processor (IOP) 14. The computer 12 and IOP 14 communicate over a peripheral component interconnect (PCI) bus 16.

In prior art systems such as system 10, inputs/outputs (IOs) are processed using non-coherent memory access between the CPU 22 and the IOP 14 over the PCI bus 16. Non-coherent memory access, as used herein, refers to mapping particular memory addresses to particular functions. Performance of a non-coherent memory access is where an operating system writes data to or reads data from a memory address having no actual memory behind it. As mentioned, these types of memory addresses (i.e. non-coherent memory addresses) are mapped to particular predetermined functions and therefore do not result in actual memory operations. Purely by way of example, in the context of non-coherent memory access, if say a “5” is written to say non-coherent memory address “75,” that operation is predetermined to relate to a particular function that will be performed by the IOP (for example, look at the next instruction in input/output control block (IOCB) 18 and perform an IO operation specified therein).

Referring still to FIG. 1, where the CPU 22 requests an IO, the information for performing that IO is written to an (IOCB) 18 within a memory 20 of the computer 12. Then, non-coherent memory access is used to inform the IOP 14 about the IOCB 18 and, once the particular IO specified in the IOCB 18 is completed, the IOP 14 interrupts the CPU 22 and then the CPU 22 uses non-coherent memory access to obtain the details of the completed IOCB. Using non-coherent memory access to communicate IO information between CPUs and IOPs is slow and inefficient.

More specifically, when using non-coherent memory access to communicate IOs between a CPU 22 and an IOP 14, data is sent out to the PCI bus where the data sits until the PCI bus becomes idle and either the CPU 22 or IOP 14 may fetch it and act on it as appropriate. This is undesirable because, for example, while the CPU 22 is waiting for the PCI bus to become idle, the CPU 22 is not performing any useful work with respect to the data it is waiting on. This causes problems with both IO initiation and IO completion. With respect to IO initiation, the CPU 22 is forced to wait for the PCI bus to become idle before initiating an IO and sending it out to the PCI bus. With respect to IO completion, although the IOP 14 interrupts the CPU 22 to provide notice that data is waiting for the CPU 22 on the PCI bus, the CPU 22 is forced to wait for the PCI bus to become idle before fetching the details of the IO completion. This causes obvious inefficiencies as the CPU 22 is not performing any useful work with respect to the processing of the particular IO that is to be initiated or that has been completed while the CPU 22 is waiting on the PCI bus.

Prior art systems may also use hardware based synchronization protocols to exchange information between two entities. Implementing such protocols requires providing each entity with locked access to memory locations thereby requiring a system to include hardware locking mechanisms such as, for example, spin locks.

It would therefore be desirable to provide a method and system wherein data related to the processing of IOs may be exchanged without waiting for the PCI bus to become available at so many stages of an IO operation and without having to utilize any hardware based messaging protocols or any hardware based synchronization protocols between IOPs and CPUs.

### SUMMARY

The present invention is a method and system for communicating information regarding input/output (IO) processing in a shared access to memory environment. A central processing unit (CPU) and an input/output processor (IOP) are configured to write to and read from predetermined memory locations to manage the detection, performance, and completion of IOs. The CPU and the IOP may read from and write to memory as desired, without unnecessary waiting for the PCI bus.

The present invention is a method and system for processing IOs that enables data related to the processing of IOs to be exchanged without the limitations of a PCI bus. Furthermore, the present invention frees the CPU/IOP protocol from the details of whatever protocol is being used by the PCI bus.

In this patent, we describe how the invention is configured, setup, and operated.

### BRIEF DESCRIPTION OF THE DRAWING(S)

FIG. 1 is a block diagram of a prior art computer system wherein IO processing is performed using a PCI bus between a CPU and an IOP.

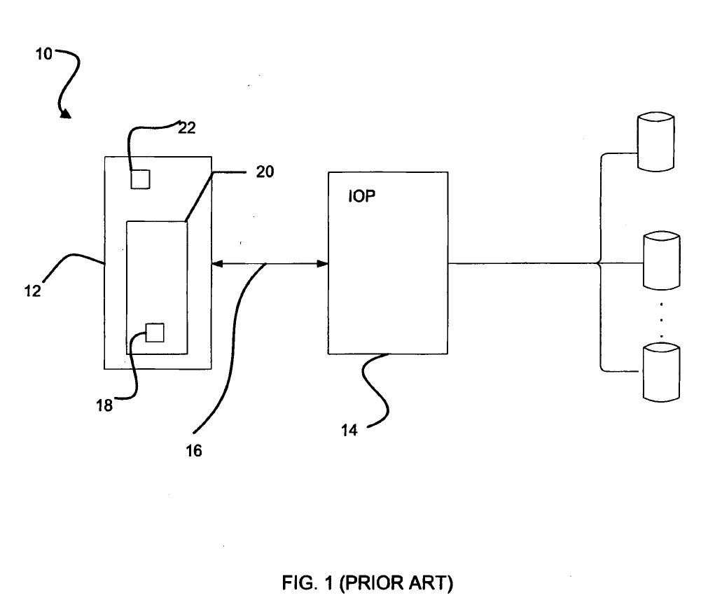

FIG. 2 is a block diagram of a computer system including a CPU, a memory, and an IOP wherein IO processing may be performed by writing to and reading from predetermined memory locations in accordance with a preferred embodiment of the present invention.

FIG. 3 is a flow chart for processing IOCBs in accordance with a preferred embodiment of the present invention.

FIG. 4 is a block diagram illustrating various data structures in accordance with a preferred embodiment of the present invention.

FIG. 5 is a flow chart illustrating a preferred embodiment of the present invention wherein a CPU stores the location of IOCBs in a request queue located in memory so that an IOP may read the IOCBs directly from memory.

FIG. 6 is a flow chart illustrating a preferred embodiment of the present invention wherein an IOP polls a request queue located in memory to find IOCBs that need to be processed.

FIG. 7 is a flow chart illustrating a preferred embodiment of the present invention wherein an IOP stores the location of processed IOCBs in a result queue located in memory so that a CPU may read the processed IOCBs directly from memory.

FIG. 8 is a flow chart illustrating a preferred embodiment of the present invention wherein a CPU polls a result queue located in memory to find processed IOCBs.

FIG. 9 is a flow chart illustrating a preferred embodiment of the present invention wherein a CPU attempts to empty a request queue sidecar.

FIG. 10 is a flow chart illustrating a preferred embodiment of the present invention wherein an IOP attempts to empty a result queue sidecar.

FIG. 11 is a block diagram of a computer system including at least two CPUs and IOPs wherein IO processing is performed by writing to and reading from predetermined memory locations in accordance with the present invention.

FIG. 12 is a block diagram of a multiple CPU/IOP system illustrating a preferred arrangement of request and result queues in accordance with a preferred embodiment of the present invention.

FIG. 13 is a block diagram illustrating the associations to and from request queues in accordance with a preferred embodiment of the present invention.

FIG. 14 is a block diagram illustrating the associations to and from result queues in accordance with a preferred embodiment of the present invention.

### DETAILED DESCRIPTION OF THE PREFERRED EMBODIMENT(S)

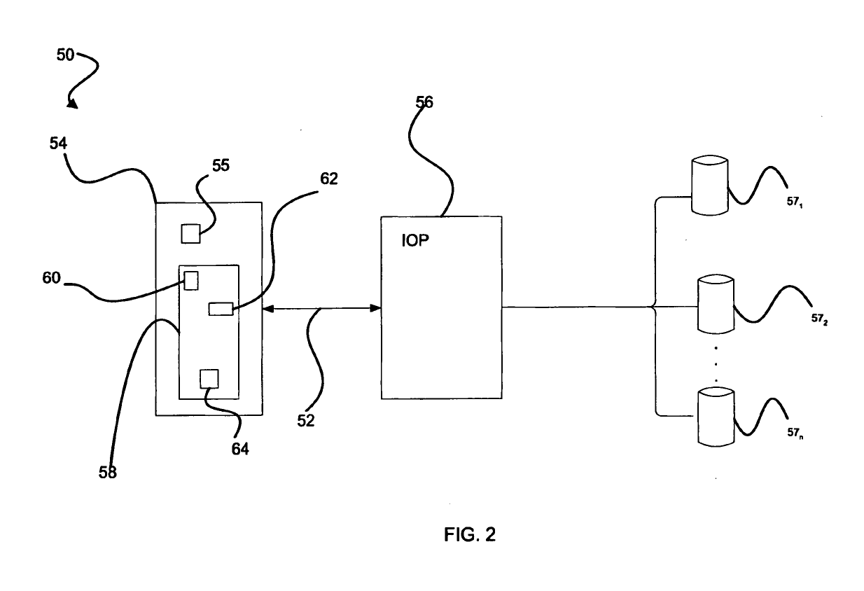

Referring now to FIG. 2, the computer system 50 of the present invention includes at least one input/output processor (IOP) 56 and a computer 54 having at least one central processing unit (CPU) 55 and at least one memory 58. It is noted that in the Figures, IOP(s) are shown separate from the complex containing the CPU(s) and memory simply for convenience in describing the present invention. In practice, IOPs are often physically distributed between components mounted inside that complex and components mounted outside. For example, the Unisys Libra Model 185 computers are an example of a prior art system wherein the IOPs are physically distributed in this manner. It is noted that computer 54 may be a personal computer, mainframe computer, or any other type of computer. It is also noted that while the IOP 56 is shown connected to disks 57ₗ-57ₙ, this is simply to illustrate that the IOP 57 may be connected to any outbound peripheral(s) such as a LAN, a tape system, etc. This is the case wherever disks are shown attached to an IOP.

Regardless of how the components are configured, in the present invention, a connection 52 is provided whereby the IOP 56 may read and write directly from/to a computer's 54 memory 58. The connection 52 may be any type of connection that allows the IOP 56 to read and write directly from/to memory 58 (i.e. any type of bridging implementation). For example, the connection may be a crossbar, system memory bus, or any other type of connection. Providing such a connection enables both the CPU 55 and IOP 56 to read/write directly from/to memory 58 thereby allowing communication regarding the processing of IOs (i.e. IO communication) to be performed without the CPU using non-coherent memory access. Generally, to facilitate IO communication without the CPU using non-coherent memory access, two types of queues 60, 62 are preferably provided in memory 58. The first type of queue 60, called a request queue, is a memory location where a CPU 55 may store requests for IO processing and an IOP 56 may read the requests for IO processing according to a predetermined schedule and process them as appropriate. Similarly, the second type of queue 62 is called a result queue. A result queue is a memory location where an IOP 56 may write information regarding processed IOs and a CPU 55 may read information on processed IOs according to a predetermined schedule thereby allowing the CPU to update the state of the processed IOs, as appropriate. There may be any number of request and result queues, as desired.

More specifically, when an IO is initiated using an IOCB, say IOCB 64, and the necessary information concerning the IO has been stored in the IOCB 64, the CPU 55 stores (i.e. writes) the location of the IOCB 64 in a request queue 60. The IOP 56, which periodically checks the request queue 60 (i.e. polls the request queue 60) to determine if there are any pending IO requests, will read the location of the IOCB 64. Based on the presence of a location of an IOCB 64 in a request queue 60, the IOP is alerted to the presence of a pending IO operation and will read IOCB 64. The IOP 56 then performs the IO operation(s) specified within IOCB 64. Then, once the IO operation(s) is complete, the IOP 56 stores the location of the IOCB in the result queue 62. The CPU 54, which periodically checks the result queue 62 (i.e. polls the result queue 62) to determine if there are any completed IOs, will read the location of the IOCB 64. Based on the presence of a location of an IOCB 64 in a result queue 62, the CPU is alerted to the presence of a processed IO and will mark the IO(s) within IOCB as complete and signal the program/report status as appropriate.

In the present invention, as mentioned above, the connection 52 may be any type of connection allowing the IOP 56 to read from and write to the computer's 54 memory 58. Such a connection is provided so that information regarding the requests and results of IOs may be communicated using queues in a memory as opposed to a PCI bus or any other type of bus. This arrangement eliminates the need for a computer to implement a PCI protocol when processing IOs and allows multiple paths to be provided between a computer and an IOP. By enabling multiple paths to be provided, a computer system may be configured to have greater load balancing, failure fallover, and throughput.

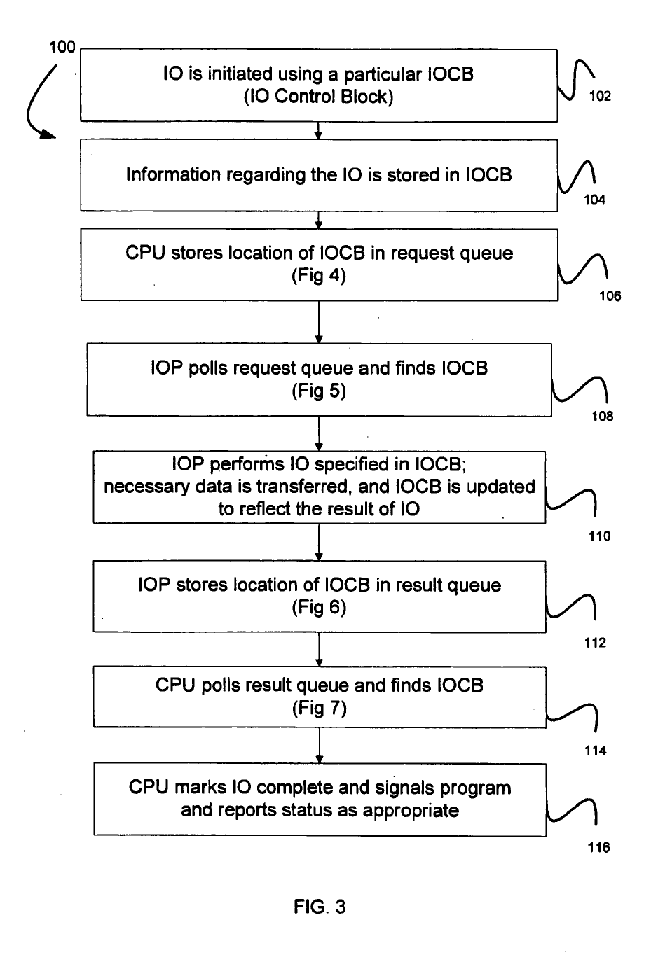

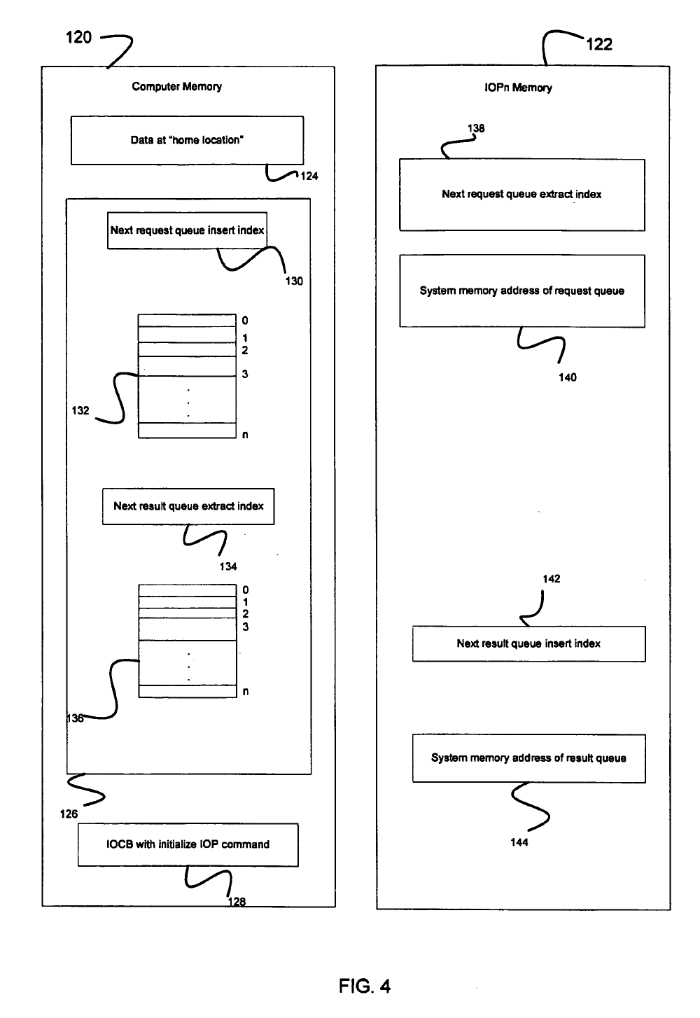

Referring now to FIG. 3, a method 100 is shown for processing IOCBs. Method 100 illustrates the general process by which information regarding IOCBs is communicated between a CPU and an IOP. For ease of explanation, the method 100 is described for a single IOCB performing a single IO. It is noted that for purposes of this explanation, the request and result queues are assumed to have been synchronized at system start-up. A more detailed explanation of system start-up and synchronization is provided in an embodiment of the invention described in connection with FIG. 4.

To begin, in step 102, an IO is initiated by an operating system of the CPU using a particular IOCB in a memory associated with a computer wherein the CPU is located. In step 104, information regarding the IO is stored in the IOCB. Once the CPU has stored information regarding the IO in the IOCB, the information in that IOCB must be communicated to the IOP for processing. In a preferred embodiment, this information is communicated by storing the location of the IOCB in a request queue in memory (step 106) thereby allowing the IOP to become aware of the IOCB by periodically reading (i.e. polling) the request queue (step 108). Once the IOP becomes aware of a particular IOCB, the IOP performs the IO specified therein, performs the necessary data transfer and then updates the IOCB to reflect the result of the IO (step 110).

Once the IOP has updated the IOCB, the fact that the IOCB has been updated needs to be communicated to the CPU so that it may mark the IO as being complete or otherwise update its state. In a preferred embodiment, this information is communicated by storing the location of the updated IOCB in a result queue in memory (step 112) thereby allowing the CPU to become aware of the IOCB by periodically polling the result queue (step 114). Once the CPU is aware of the updated IOCB, the CPU marks the IO initiated in step 102 as being complete and signals the program that issued the IO and reports status as appropriate (step 116).

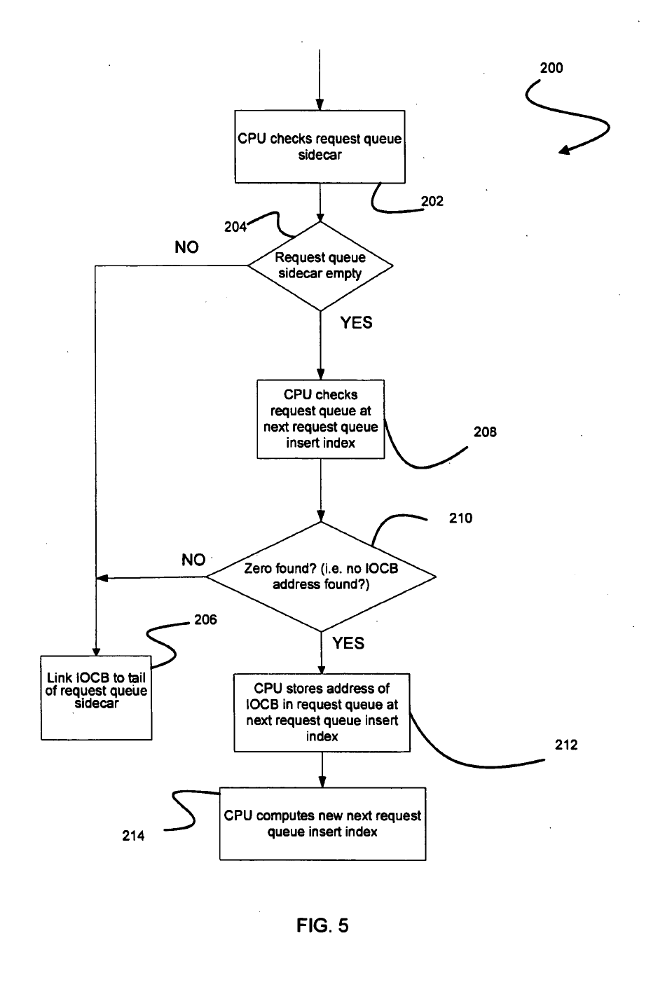

While the method 100 described above is described in connection with a single IOCB having a single IO, in practice there will be many IOCBs, each running a particular IO, at many different stages being processed at any given time. It is noted that embodiments of the present invention are possible where a single IOCB may specify multiple IOs to be performed by the IOP in parallel or in sequence. Embodiments are also possible where an IOCB which is processed through the request and result queue mechanism of method 100 has a linked chain of zero or more IOCBs chained to it that need to be performed by the IOP in parallel or in sequence with a previous IOCB. Therefore, steps 106, 108, 110, 112, which each represent individual processes, will usually be all executing at once and processing different IOCBs. Furthermore, there may also be a plurality of CPUs and IOPs whereby multiple copies of each process is executing at once. The individual processes are represented in FIGS. 5-8 respectively. Therefore, it is important to note that the processes shown in FIGS. 5-8 are typically executing continually, but with different IOCBs.

Prior to describing the individual process in detail as shown in FIGS. 5-8, it is important to note that, as mentioned above, in order for a CPU and an IOP to communicate by writing to and periodically reading from predetermined memory locations, the CPU and IOP are preferably synchronized at start-up. Referring now to FIG. 4, a description of an embodiment of the invention for synchronizing CPU(s) and IOP(s) at start-up is provided. Of course, synchronization may be performed in a variety of ways and the description provided herein is provided by way of example.

In FIG. 4, data structures within a computer memory 120 and the memory 122 of a particular IOP (i.e. IOPₙ) is shown. The data structures that are shown are the data structures involved in initializing the state of IOPₙ. In the computer memory 120, a home location 124 is provided along with data structures that are specific to IOPₙ, and an IOCB 128 having an initialize IOP command. The home location is a fixed predetermined location in memory 120. This location is preferably hard coded in the operating system and in the IOP micro code. The computer memory 120 at the home location 124 contains zeros, except when used as described herein during initialization (i.e. synchronization). The IOCB 128 with an initialize IOP command is the first IOCB that is found by IOPₙ during IOPₙ's first request queue poll.

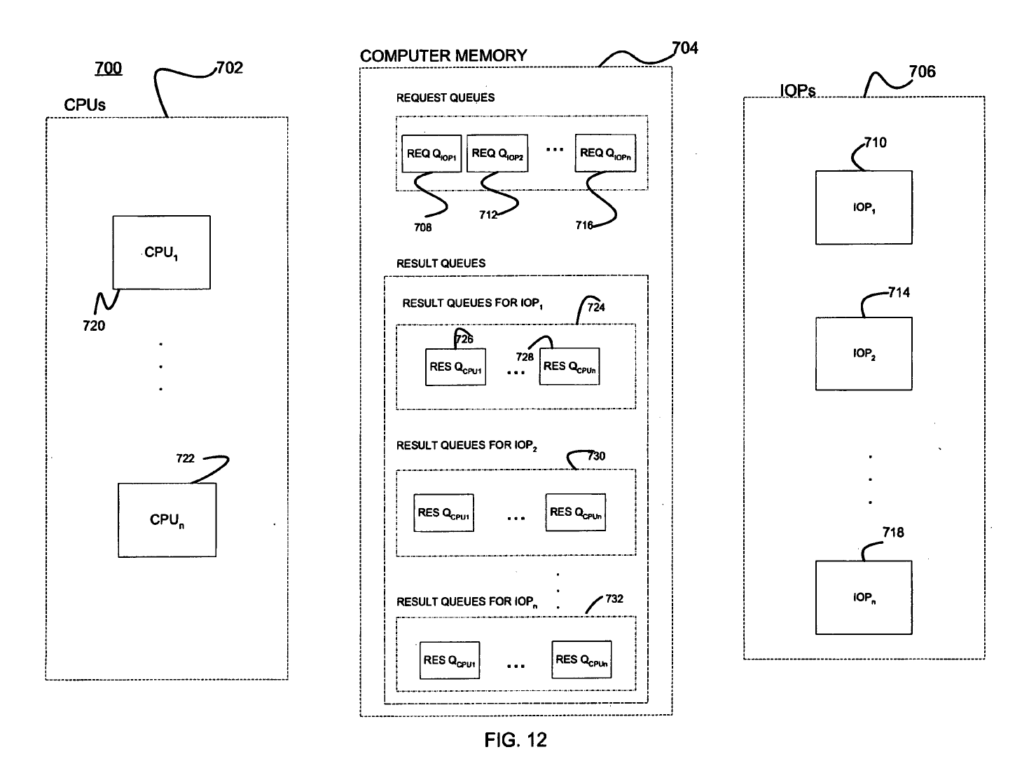

With respect to data structures 126, there is a next request queue insert index 130 and request queue 132 as well as a next result queue extract index 134 and result queue 136. In the IOPₙ memory 122 there is a next request queue extract index 138 and a system memory address of the request queue 140 as well as a next result queue insert index 142 and a system memory address of result queue 144. It is noted that it is preferable to provide IOPₙ with a separate result queue for each CPU as explained in detail in FIGS. 12-14. In FIG. 4, however, for simplicity, there is only one CPU so IOPₙ is provided with only one result queue 136.

To initialize or otherwise synchronize a CPU and IOP, the data structures in memories 120 and 122 preferably function and are utilized as follows. The operating system of the computer to whom computer memory 120 belongs allocates a request queue 132, a next request queue insert index 130, a result queue 136, and a next result queue extract index 134. As mentioned above, these data structures are all for exclusive use for IOPₙ and are all initialized to zero. The operating system then allocates an IOCB, and sets it up as an initialize IOP command. This IOCB is the IOCB 128 with initialize IOP command. The initialize IOP command includes various parameters, one of which is the address in computer memory 120 of the result queue 136.

Once the operating system has set up the data structures 126 and IOCB 128 with initialize IOP command, the operating system then stores the computer memory 120 address of IOCB 128 in entry zero (0) of the request queue 132 and increments the next request queue insert index 130 so that the next IOCB may be placed in entry one (1), for example. The home location 124 holds several fields, all of which are preferably stored in a single atomic memory operation (i.e. an operation that can be done in such a way that no intervening operation can occur). The two fields that are particularly relevant to synchronization hold the IOP number of the IOP being initialized and the computer memory 120 address of the request queue 132 and are stored by the operating system.

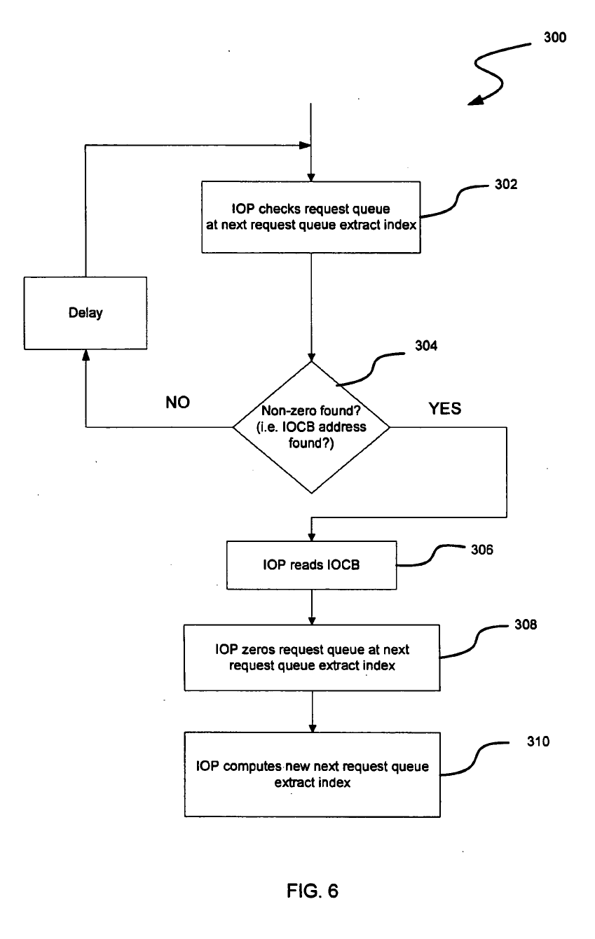

While the operations described in the previous two paragraphs are being performed, any uninitialized IOPs (including IOPₙ which is the IOP currently being initialized) have been polling the home location 124 in computer memory 120. This is the state in which all of the IOPs power up in. The intended IOP (in this case IOPₙ), however, sees its IOP number the next time it polls the home location 124. IOPₙ then sets its system memory address of the request queue 140 to the value found in the home location 124 (i.e. the address of the request queue 132), sets its next request queue extract index to zero, and initiates the request queue polling process, the details of which are described in FIG. 6. It is noted that IOPₙ will also zero (0) the home location 124. Now that IOPₙ has been given the address of the request queue 132, the first time IOPₙ polls the request queue 132, it will find the address of the IOCB 128 with the initial IOP command. While processing IOCB 128, the computer memory 120 address of the result queue is set to the value found in IOCB 128, and the next result queue insert index is set to zero. At this point, both the request queue and the result queue are now known to both the operating system and the IOP, and the insert and extract points for both queues are properly synchronized and they may each read and write from the queues 132 and 136 as explained in FIGS. 5-8 as well as perform other memory operations as desired.

There is also an IOP reset command that causes an IOP to re-initialize itself to its initial state wherein it is polling the home location 124 in computer memory 120. This may be used, for example, by the operating system when executing a software initiated system restart. It is noted that each IOP has its IOP number previously supplied to it via some type of out of band mechanism. For example, in a preferred embodiment of the invention, the IOP number is stored in flash memory of an IOP, and set via maintenance protocol over a RS232 serial port on the IOP. It is also noted that zero (0) is never used as an IOP number as the home location 124 contains all zeroes as its default state. Of course, the above initialization/synchronization process may vary with the key point being that in order for a CPU and IOP to communicate using queues in a memory, the CPU and IOP must be synchronized with respect to queue locations and insert/extract indexes.

Referring now to FIG. 5, there is shown a method 200 wherein a CPU stores the location of an IOCB in a request queue located in memory so that an IOP may read the IOCB directly from memory. Method 200, in one embodiment, is the preferred process by which a CPU communicates IOCB processing requests (i.e. requests) to an IOP.

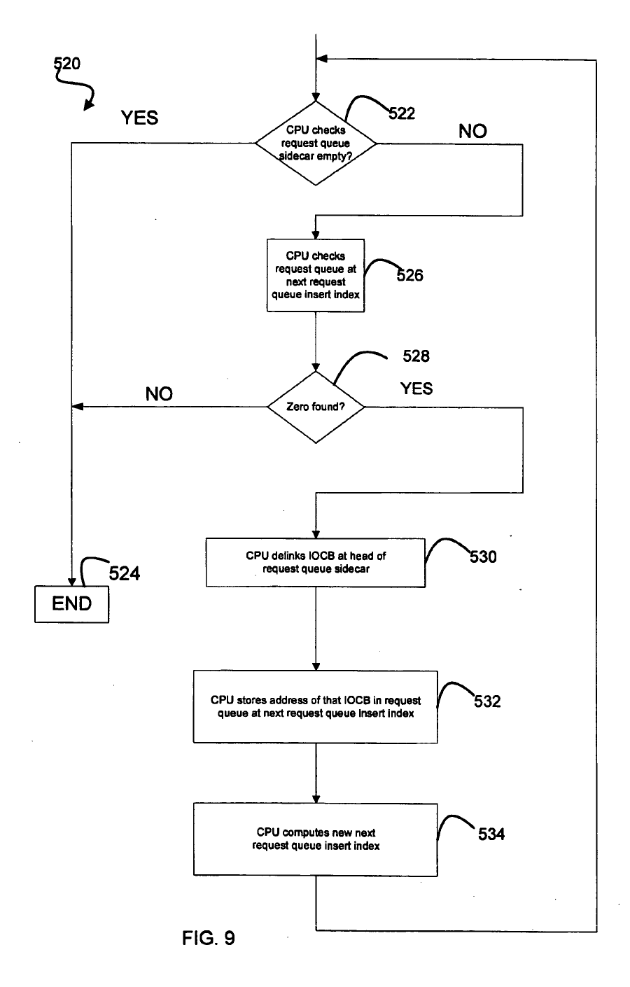

The method 200 begins in step 202 wherein the CPU of the computer that originated the IO checks a request queue side car to determine whether the request queue sidecar is empty. If the request queue sidecar is not empty, the method 200 proceeds to step 206 wherein the IOCB is linked to the tail of the request queue sidecar. The request queue sidecar holds pending IOCBs (i.e IOCBs that need to be processed) that do not fit in the request queue. The CPU will periodically attempt to empty the sidecar in accordance with the process shown in FIG. 9.

If the request queue sidecar is empty, the method 200 proceeds from step 204 to step 208 wherein the CPU checks the request queue at the next request queue insert index to determine whether the IOCB can be placed in the request queue. The request queue insert index is preferably an integer that is accessed only by the CPUs.

If, as a result of checking the request queue in step 208, a zero is not found, the method 200 proceeds from step 210 to step 206 wherein the IOCB is linked to the tail of the request queue sidecar. If a zero is found, the method 200 proceeds to step 212 where the CPU stores the address of the IOCB in the request queue at the index specified by the next request queue insert index.

Once the IOCB address is stored in the request queue, the CPU computes a new next request queue insert index in step 214. The new next request queue insert index is computed according to:

I_{new}=(I+1)MOD L; Equation (1)

where I_{new} is the new next request queue insert index, I is the next request queue insert index, L is the length of the request queue, and MOD is an operator specifying that I_{new} new is the integer remainder obtained when (I+1) is divided by L.

Referring now to FIG. 6, there is shown a method 300 wherein an IOP polls a request queue located in memory to find IOCBs that need to be processed. Method 300, in one embodiment, is the preferred process by which an IOP receives or otherwise becomes aware of IOCB processing requests (i.e. requests) issued by a CPU.

The method 300 begins in step 302 wherein an IOP checks a request queue at the next request queue extract index. The extract index is preferably an integer accessed only by the IOP and the integer is preferably stored internal to the IOP.

In step 304, if a non-zero (i.e. an IOCB address) is not found, the method 300 cycles back to step 302 after some predetermined delay. If a non-zero (i.e. an IOCB address) is found, the method 300 proceeds from step 304 to step 306 wherein the IOP reads the IOCB corresponding to the address found in the request queue. Then, in step 308, the IOP zeroes the request queue at the next request queue extract index thereby indicating that the IOCB has been extracted from the request queue. In step 310, the IOP computes a new next request queue extract index. The new next request queue extract index is computed according to:

I_{new}=(I+1)MOD L; Equation (2)

where I_{new} is the new next request queue extract index, I is the next request queue extract index, L is the length of the request queue, and MOD is an operator specifying that I_{new} is the integer remainder obtained when (I+1) is divided by L.

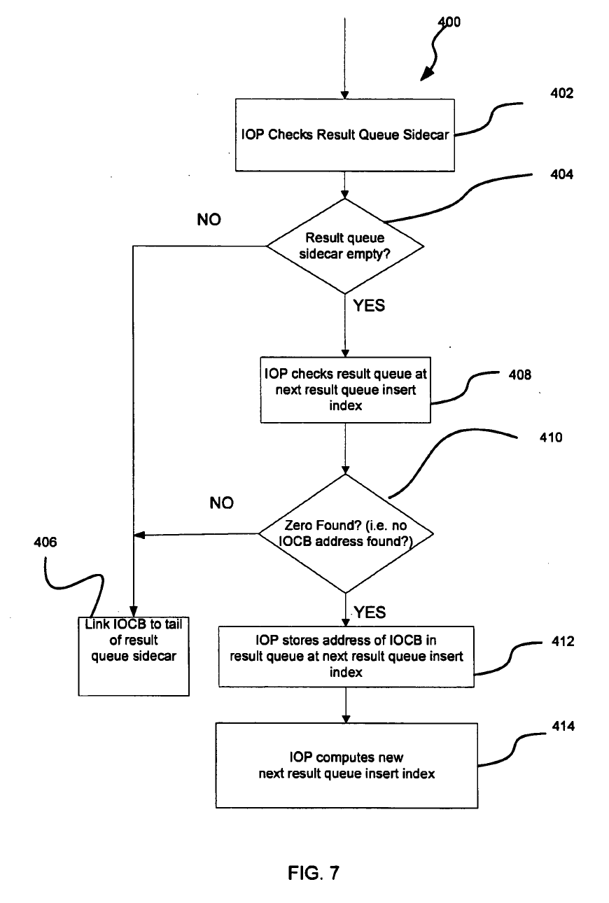

Referring to FIG. 7, a method 400 is shown wherein an IOP stores the location of a processed IOCB in a result queue located in memory so that a CPU may read the processed IOCB directly from memory. Method 400, in one embodiment, is the preferred process by which an IOP communicates the status of completed IOCBs (i.e. results) to a CPU.

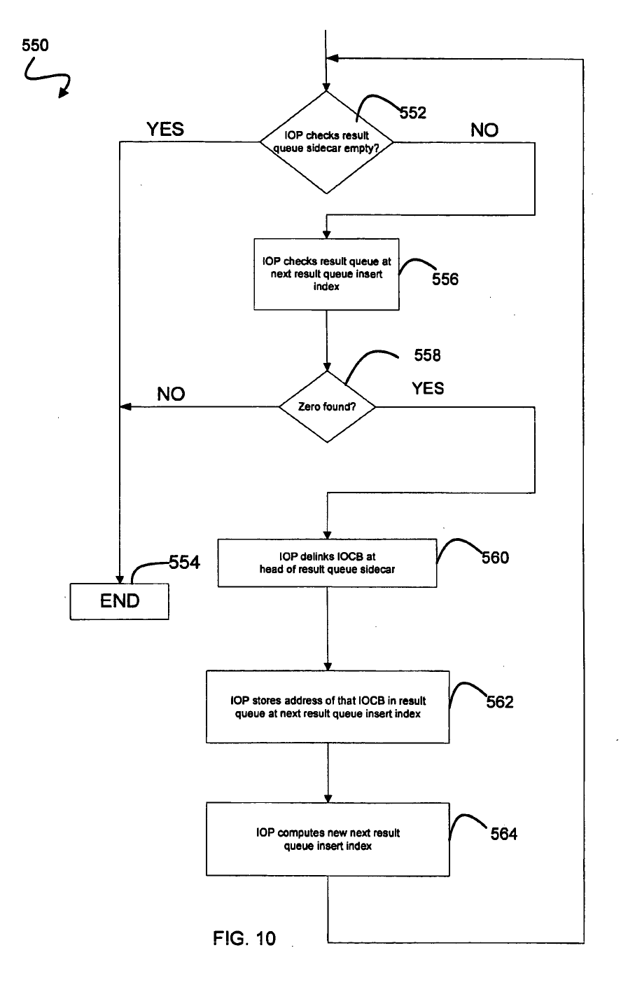

The method 400 begins in step 402 wherein the IOP checks its result queue sidecar to determine whether the result queue sidecar is empty. The result queue sidecar is where IOCBs are stored when they can not be placed in the IOP's result queue. If the result queue sidecar is not empty, the method 400 proceeds from step 404 to step 406 wherein the IOCB is linked to the tail of the result queue sidecar. A result queue sidecar is a list of IOCBs that is used to hold completed IOCBs which do not currently fit in the result queue. The result queue sidecar list is private to the relevant IOP. In a preferred embodiment, the list is implemented as a linked list. The IOP will periodically attempt to empty the sidecar according to the process described in FIG. 10.

If the result queue sidecar is empty, the method 400 proceeds from step 404 to step 408 wherein the IOP checks the result queue at the next result queue insert index to determine whether the IOCB can be placed in the result queue. The result queue insert index is preferably an integer that is accessed only by the relevant IOP.

If, as a result of checking the result queue in step 408, a zero is not found, the method 400 proceeds from step 410 to step 406 wherein the IOCB is linked to the tail of the result queue sidecar. If a zero is found, the method 400 proceeds to step 412 where the IOP stores the address of the IOCB in the result queue at the index specified by the next result queue insert index (i.e. at the location of where the zero was found).

Once the IOCB address is stored in the result queue, the CPU computes a new next result queue insert index in step 414. The new next result queue insert index is computed according to:

I_{new}=(I+1)MOD L; Equation (3)

where I_{new} is the new next result queue insert index, I is the next result queue insert index, L is the length of the result queue, and MOD is an operator specifying that I_{new} is the integer remainder obtained when (I+1) is divided by L.

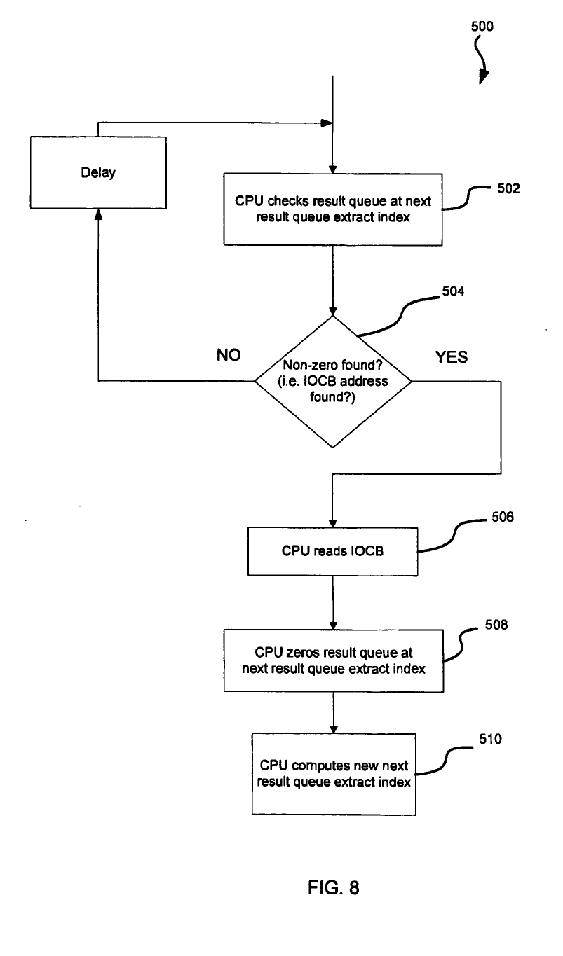

Referring now to FIG. 8, there is shown a method 500 wherein a CPU polls a result queue located in memory to find processed IOCBs so that the CPU may update their status accordingly. Method 500, in one embodiment, is the preferred process by which a CPU receives or otherwise becomes aware of completed IOCBs (i.e. results).

The method 500 begins in step 502 wherein a CPU checks a result queue at the next result queue extract index. The extract index is preferably an integer accessed only by the CPUs.

In step 504, if a non-zero (i.e. an IOCB address) is not found, the method 500 cycles back from step 504 to step 502 after some predetermined delay. If a non-zero (i.e. an IOCB address) is found, the method 500 proceeds to step 506 wherein the CPU reads the IOCB corresponding to the address found in the result queue. Then, in step 508, the CPU zeroes the result queue at the next result queue extract index. In step 510, the IOP computes a new next result queue extract index. The new next result queue extract index is computed according to:

I_{new}=(I+1)MOD L; Equation (4)

where I_{new} is the new next result queue extract index, I is the next result queue extract index, L is the length of the result queue, and MOD is an operator specifying that I_{new} is the integer remainder obtained when (I+1) is divided by L.

As mentioned, methods 300 and 500 will preferably be running continually, methods 200 and 400 will be running as needed, and all four methods may be running concurrently. Furthermore, multiple copies of each method may be running continually, as needed, depending on the number of IOCBs being processed.

As mentioned in the description of FIG. 5, the CPU will periodically attempt to empty the request queue sidecar as shown in FIG. 9. To begin, the CPU checks to see if the request queue sidecar is empty in step 522. If the request queue sidecar is empty there is no need to empty it and the method 520 ends in step 524. If the request queue sidecar is not empty, the method 520 proceeds to step 526 where the CPU checks the request queue at the next request queue insert index. If a zero is not found in step 528, there are no openings in the request queue and the sidecar therefore can not be emptied and the method 520 ends in step 524. If there is a zero found in step 528, there is an open space and the method 520 proceeds to step 530. In step 530, the CPU delinks the IOCB at the head of the request queue sidecar and in step 532 stores the address of that delinked IOCB in the request queue at the next request queue insert index. Then, the CPU increments the next request queue insert index. The increment is preferably performed according to Equation 1 above. The method 520 then cycles back to step 522.

As mentioned in the description of FIG. 7, the IOP will periodically attempt to empty the result queue sidecar as shown in FIG. 10. To begin, the IOP checks to see if the result queue sidecar is empty in step 552. If the result queue sidecar is empty there is no need to empty it and the method 550 ends in step 554. If the result queue sidecar is not empty, the method 550 proceeds to step 556 where the IOP checks the result queue at the next result queue insert index. If a zero is not found in step 558, there are no openings in the result queue and the sidecar therefore can not be emptied and the method 550 ends in step 554. If there is a zero found in step 558, there is an open space and the method 550 proceeds to step 560. In step 560, the IOP delinks the IOCB at the head of the result queue sidecar and in step 562 stores the address of that delinked IOCB in the result queue at the next result queue insert index. Then, the IOP increments the next result queue insert index. The increment is preferably performed according to Equation 3 above. The method 550 then cycles back to step 552.

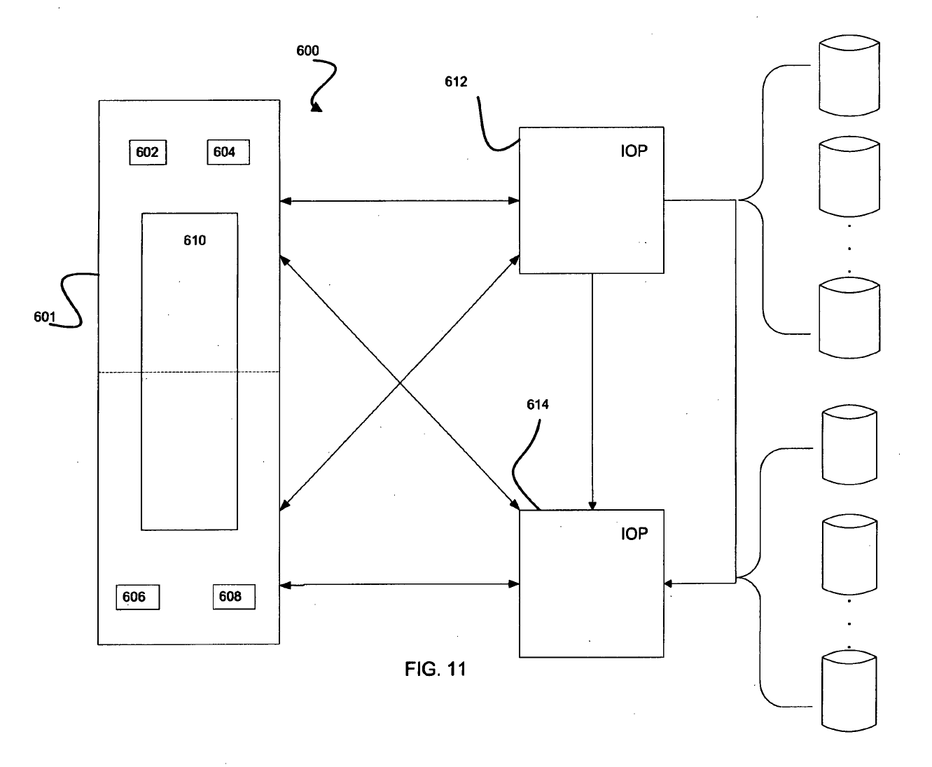

Referring now to FIG. 11, it is important to note that the present invention may be implemented using any number of CPUs and IOPs. In system 600, there are four CPUs 602, 604, 606, 608, one memory 610, and two IOPs 612, 614. As can be seen in FIG. 11, the IOPs 612,614 and CPUs 602, 604, 606, 608 are fully connected such that they may operate in parallel to expedite processing of IOCBs. Also, the CPU/memory complex 601 may be partitioned (see dashed line) such that CPUs 602 and 604, half of memory 610, and one IOP run as one system and CPUs 606, 608, the other half of memory 610, and the other IOP run as another system. If more IOPs are configured, they can be distributed among the partitions as desired. FIG. 11 illustrates only one possible embodiment, but it is noted that any number of additional embodiments are possible. For example, systems may be configured with more CPUs and IOPs, with more than two potential partitions, and with IOPs either connected via multiple paths (as shown) or via single paths.

As briefly mentioned above, where there are multiple CPUs and IOPs, it is preferable with respect to the request queues to have one request queue for each IOP. That is, it is preferable for all IO requests for a particular IOP, say IOPx, to be put into a single request queue that is polled only by IOPₓ. Therefore, the preferred number of request queues in a multiple CPU/IOP system is equal to the number of IOPs in the system. With respect to result queues, it is preferable for each IOP to have a separate result queue for each CPU. Therefore, the preferred number of result queues in a multiple CPU/IOP system is equal to the number of IOPs multiplied by the number of CPUs. To further illustrate this concept, reference is made to FIGS. 12-14.

In the system 700 shown in FIG. 12, there are n CPUs 702, a computer memory 704, and n IOPs 706. For each IOP there is a request queue wherein any of the n CPUs may place IOs that they want processed by that particular IOP. Therefore, in FIG. 12, there is request queue 708 that corresponds to IOP₁ 710, a request queue 712 that corresponds to IOP₂ 714, and a request queue 716 that corresponds to IOPₙ 718. If CPU₁ 720 or CPUₙ 722 has an IO to be processed by IOP₂ 714, they will send the IO to request queue 712. Furthermore, each IOP is preferably provided with a result queue for each CPU. For example, the result queues 724 for IOP₁ 710 include a result queue 726 for CPU₁ 720 and a result queue 728 for CPUₙ 722. This same arrangement is provided for IOP₂ 714 and IOPₙ 718 as shown in result queues 730 and 732.

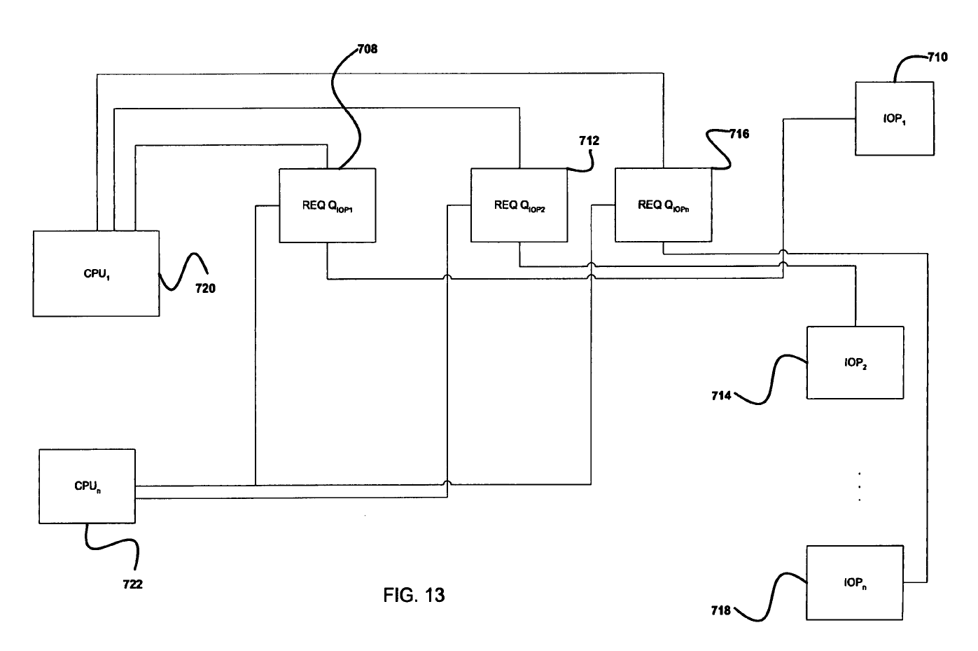

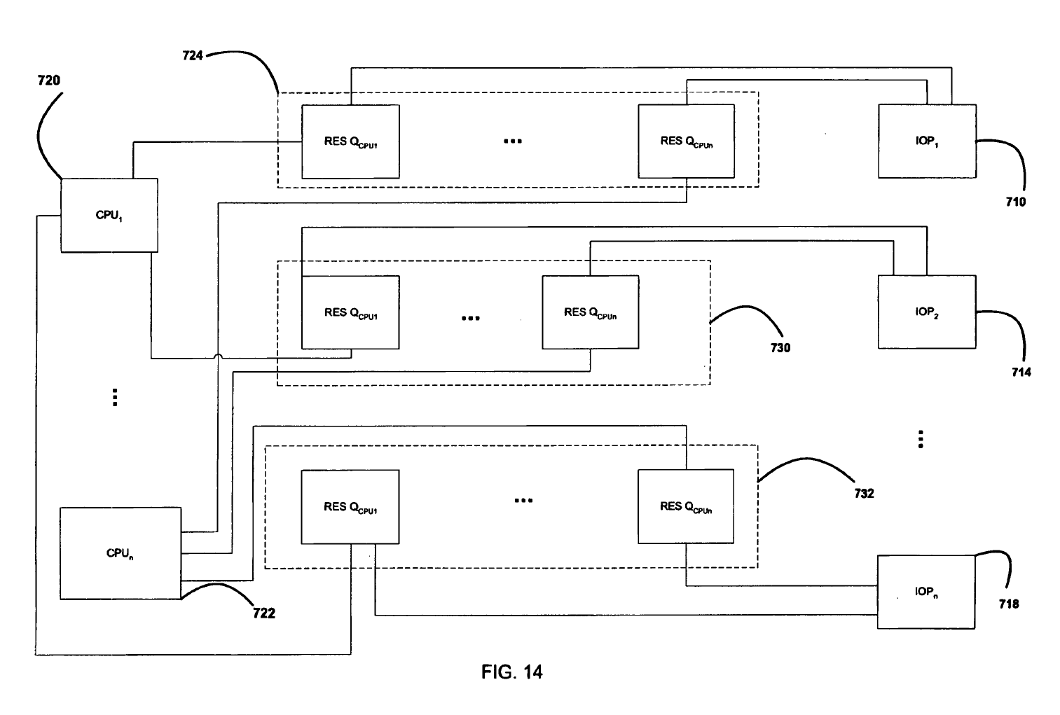

To further illustrate this concept, reference is made to FIGS. 13 and 14. In FIG. 13, associations to and from request queues 708, 712, 716 are shown. As explained above, there is an association from each CPU to each request queue and each request queue is associated with a particular IOP. This allows all IO request for a particular IOP to be placed in a single request queue (i.e. the request queue that corresponds to the particular IOP).

In FIG. 14, associations to and from result queues 724, 730, 732 are shown. This arrangement is preferred in multiple CPU/IOP systems to address the issue that CPUs typically have caches which cache the memory data that the CPU has used most recently. That is, when a program issues an IO and then waits for it to complete, much of the program's data may still be cached in the cache associated with the CPU on which it last ran. Thus, there is a significant performance advantage to having the program resume running on that CPU. To efficiently ensure that this is the case, the present invention provides multiple result queues that are associated with the IOPs and CPUs as shown in FIG. 14 and specifies in each IOCB the result queue in which the IOP processing the IOCB should place the results.

In a preferred implementation, the result queue set up by the initialize IOP command described in connection with FIG. 4 is always the IOP's first result queue (i.e. for IOP₁ 710 the first result queue may be result queue 726). Then, the operating system allocates memory space for additional result queues (depending on the number of CPUs) for the IOP and uses IOCBs containing setup result queue commands to inform the IOP of the additional result queue(s). Each additional result queue has its own data structures in both computer memory and IOP memory as previously explained, and initializes and operates just like the first result queue. The setup result queue command may be used to convey the integers to be used by the IOP to refer to its result queues. As shown in FIG. 14 and previously explained, it is preferable to set one result queue per CPU for each IOP. Once the result queues are set up, the operating system just has to have the CPU associated with a given result queue poll that particular result queue for each IOP because it can direct IOCBs issued while running on a particular CPU to the result queues associated with that CPU.

By way of example, referring back to FIG. 13, assume CPU₁ 720 places an IOCB in request queue 708 and IOP₁ 710 processes it; IOP₁ 710, turning now to FIG. 14, will place the results in result queue 726. Therefore, efficiencies are gained in that there is a guarantee that the process will resume on the issuing CPU (i.e. CPU₁ 720).

In another embodiment, an additional result queue per IOP may be allocated and used only by the mechanism which takes a diagnostic snapshot of computer memory when something goes wrong. That is, traditionally, the operating system has had to completely quiet the IO subsystem before taking a diagnostic snapshot. With a set of separate result queues for use in taking a diagnostic snapshot, it becomes more likely that the diagnostic snapshot will be taken successfully if the problem is related to the IO subsystem. Even if the problem is not related to the IO subsystem, taking the diagnostic snapshot without completely quieting the IO subsystem may produce a diagnostic snapshot in which it is easier to see exactly what was happening when the problem occurred. Additionally, it is noted that although particular arrangements have been shown with respect to the result and request queues, it is of course possible to arrange them as desired. For example, in a multiple CPU/IOP system, one request queue may be provided for each IOP/CPU pair. Also, it should be noted that the result and request queues may be of any size as desired.

A particular advantage of the present invention is that it allows IOPs (56) to be constructed with commodity hardware and software and connected to computers (54) via commodity memory interconnect hardware which does not support hardware based messaging protocols, and does not support hardware based synchronization protocols (such as spin locks). One embodiment of the present invention uses commodity server computers running Linux as IOPs (56) and commodity non-transparent PCI to PCI bridges as memory interconnect (52), the IOP based algorithms described herein running as programs under Linux.

It is noted that the present invention may be implemented in a variety of systems and that the various techniques described herein may be implemented in hardware or software, or a combination of both. Furthermore, while the present invention has been described in terms of various embodiments, other variations, which are within the scope of the invention as outlined in the claims below will be apparent to those skilled in the art.

1. A method for communicating information regarding processing of inputs/outputs (IOs) in shared access to memory environments, the method comprising the steps of:
initiating at least one IO in a central processing unit (CPU);
storing control information for processing the IO in an input/output control block (IOCB);
writing the location of the IOCB by the CPU to a shared memory, without having to lock the shared memory to write the location of the IOCB;
polling the shared memory by an input/output processor (IOP) to determine if there are any pending IO requests by reading the IOCB location from the shared memory;
reading the IOCB by the IOP if there are pending IO requests;
storing the location of the IOCB in the shared memory by the IOP after the IO operation is complete, without having to lock the shared memory to store the location of the IOCB;
polling the shared memory by the CPU to determine if there are any completed IOs; and
reading the IOCB by the CPU if there are completed IOs.

2. The method of claim 1 wherein the writing step includes the CPU writing the location of the IOCB to a request queue in the shared memory, without having to lock the shared memory to write the location of the IOCB to the request queue.

3. The method of claim 2 wherein the IOP reads the IOCB from the request queue.

4. The method of claim 3 wherein the IOP polls the request queue according to a predetermined schedule.

5. The method of claim 1 wherein the storing step includes the IOP storing the location of the IOCB in a result queue in the shared memory, without having to lock the shared memory to store the location of the IOCB in the result queue.

6. The method of claim 5 wherein the CPU reads the IOCB from the result queue.

7. The method of claim 6 wherein the CPU polls the result queue according to a predetermined schedule.

8. The method of claim 6 further including the step of:
marking the IO as complete once the CPU has read the information regarding the result from the result queue.

9. The method of claim 1 wherein the IOCB includes a plurality of IOCBs, each IOCB having a plurality of IOs.

10. The method of claim 1 wherein the IOP and the CPU may both access the shared memory simultaneously.

11.-23. (canceled)

24. A system for communicating information regarding input/output (IO) processing, comprising:
a shared memory including an input/output control block (IOCB), said IOCB including control information for processing an IO, wherein said shared memory does not need to be locked to write to said shared memory and to read from said shared memory;
a central processing unit (CPU), configured to write a location of said IOCB to said shared memory and to read a location of said IOCB from said shared memory; and
an input/output processor (IOP), configured to write a location of said IOCB to said shared memory and to read a location of said IOCB from said shared memory.

25. The system of claim 24, wherein said shared memory includes a request queue, said CPU configured to write the location of said IOCB to said request queue, said IOP configured to read the location of said IOCB from said request queue.

26. The system of claim 24, wherein said shared memory includes a result queue, said IOP configured to write the location of said IOCB to said result queue, said CPU configured to read the location of said IOCB from said result queue.

27. The system of claim 24, wherein said IOP is further configured to poll said shared memory to determine if there are any pending IO requests.

28. The system of claim 24, wherein said CPU is further configured to poll said shared memory to determine if there are any completed IOs.
